(19) United States
(12) Patent Application Publication
(10) Pub. No.: US 2018/0159706 A1
(43) Pub. Date: Jun. 7, 2018

(54) Radio-Frequency Apparatus with Digital Signal Arrival Detection and Associated Methods

(71) Applicant: Silicon Laboratories Inc., Austin, TX (US)

(72) Inventors: Ping Xiong, Sunnyvale, CA (US); Hendricus de Ruijter, Sunnyvale, CA (US); Amey Naik, Austin, TX (US); Yan Zhou, Austin, TX (US)

(21) Appl. No.: 15/370,674

(22) Filed: Dec. 6, 2016

(51) Int. Cl. H04L 27/22; H04B 1/16

(52) U.S. Cl. CPC H04L 27/22; H04B 1/16

(57) ABSTRACT

An apparatus includes a radio frequency (RF) receiver, which includes a digital signal arrival (DSA) detector to detect arrival of a transmitted signal. The DSA detector includes a frequency discriminator to receive a signal derived from a received RF signal to generate a first complex signal. The DSA detector further includes a correlator coupled to receive and process the first complex signal and to generate a second complex signal. The DSA detector in addition includes a Coordinate Rotation Digital Computer (Cordic) circuit to receive and process the second complex signal to generate a phase signal and a magnitude signal.

### TECHNICAL FIELD

The disclosure relates generally to communication apparatus and associated methods. More particularly, the disclosure relates to apparatus for receivers with digital signal arrival (DSA) circuits, and associated methods.

### BACKGROUND

With the increasing proliferation of wireless technology, such as Wi-Fi, Bluetooth, and mobile or wireless Internet of things (IoT) devices, more devices or systems incorporate radio frequency (RF) circuitry, such as receivers and/or transmitters. To reduce the cost, size, and bill of materials, and to increase the reliability of such devices or systems, various circuits or functions have been integrated into integrated circuits (ICs). For example, ICs typically include receiver and/or transmitter circuitry. A variety of types and circuitry for transmitters and receivers are used. Transmitters send or transmit information via a medium, such as air, using RF signals. Receivers at another point or location receive the RF signals from the medium, and retrieve the information. Typically, transmitters transmit coded data via RF signals. Receivers receive, decode, demodulate, etc. the RF signals to retrieve the data.

Some wireless communication standards define a preamble for a wireless packet, which is a predefined data pattern that a receiver can use to detect and settle its control loops. The control loops may include the Automatic Gain Control (AGC), Automatic Frequency Compensation (AFC), and Bit Clock Recovery (BCR). After the receiver detects the end of the preamble, the receiver is prepared to receive a full packet including payload data. Some receivers use a preamble detector to detect the arrival of a frame. In response to the preamble detector signaling the detection of the preamble, the receiver begins looking for the next portion of the frame. In the M-bus frame protocol, this next portion is a synchronization word (SYNC word). Under certain circumstances, the preamble detector can occasionally provide a false trigger, such as when a co-channel continuous wave (CW) tone is received at around sensitivity of the preamble detector, or when certain noise patterns are received.

The description in this section and any corresponding figure(s) are included as background information materials. The materials in this section should not be considered as an admission that such materials constitute prior art to the present patent application.

### SUMMARY

A variety of communication apparatus and associated methods are contemplated. According to an exemplary embodiment, an apparatus includes a radio frequency (RF) receiver, which includes a digital signal arrival (DSA) detector to detect arrival of a transmitted signal. The DSA detector includes a frequency discriminator to receive a signal derived from a received RF signal to generate a first complex signal. The DSA detector further includes a correlator coupled to receive and process the first complex signal and to generate a second complex signal. The DSA detector in addition includes a Coordinate Rotation Digital Computer (Cordic) circuit to receive and process the second complex signal to generate a phase signal and a magnitude signal.

According to another exemplary embodiment, an integrated circuit (IC) includes an RF receiver, which includes a frequency discriminator to process a signal derived from a received RF signal to generate a first complex signal. The RF receiver also includes a correlator that includes a plurality of finite impulse response (FIR) filters coupled to receive and process the first complex signal and to correlate a phase of the first complex signal with a phase pattern to generate a second complex signal. The RF receiver further includes a Cordic circuit to receive and process the second complex signal to generate a phase signal and a magnitude signal.

According to another exemplary embodiment, a method receiving radio frequency (RF) signals includes processing a signal derived from an RF signal in a frequency discriminator to generate a first complex signal, and filtering the first complex signal in a correlator to generate a second complex signal. The method further includes generating a phase signal and a magnitude signal by processing the second complex signal in a Cordic.

### BRIEF DESCRIPTION OF THE DRAWINGS

The appended drawings illustrate only exemplary embodiments and therefore should not be considered as limiting the scope of the application or the claims. Persons of ordinary skill in the art will appreciate that the disclosed concepts lend themselves to other equally effective embodiments. In the drawings, the same numeral designators used in more than one drawing denote the same, similar, or equivalent functionality, components, or blocks.

FIG. 1 illustrates a circuit arrangement for a receiver according to an exemplary embodiment.

FIG. 2 depicts a circuit arrangement for a receiver according to an exemplary embodiment.

FIG. 3 shows a system for radio communication according to an exemplary embodiment.

FIG. 4 depicts a circuit arrangement for receive path circuitry according to an exemplary embodiment.

FIG. 5 illustrates a circuit arrangement for receive path circuitry according to another exemplary embodiment.

FIG. 6 shows a circuit arrangement according to an exemplary embodiment that includes a gain circuit.

FIG. 7 depicts a circuit arrangement that includes a frequency discriminator and a correlator according to an exemplary embodiment.

FIG. 8 illustrates a correlator according to an exemplary embodiment.

FIG. 9 shows an example of the input signal of a frequency discriminator according to an exemplary embodiment.

FIG. 10 depicts a block diagram of an IC according to an exemplary embodiment.

### DETAILED DESCRIPTION

The disclosed concepts relate generally to communication circuitry, such as RF receivers or transceivers. More specifically, the disclosed concepts provide apparatus and methods for receivers with digital signal arrival (DSA) circuits or detectors, which detect the arrival of a transmitted signal, for example, a transmitted frame, packet, etc. In exemplary embodiments, DSAs may be used in a variety of receivers. Such receivers may use desired modulation schemes, for instance, to implement RF communication using standards or protocols, such as Bluetooth or its variations (e.g., Bluetooth low energy (BLE).

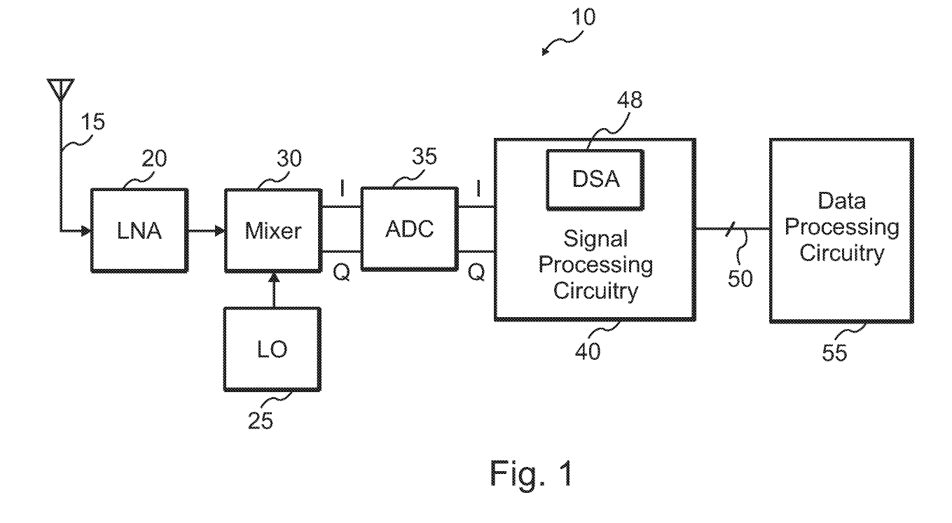

FIG. 1 illustrates a circuit arrangement for a receiver 10 according to an exemplary embodiment. Receiver 10 receives RF signals via antenna 15. The RF signals feed an input of low noise amplifier (LNA) 20. LNA 20 provides low-noise amplification of the RF signals, and provides amplified RF signals to mixer 30.

Mixer 30 performs frequency translation or shifting of the RF signals, using a reference or local oscillator (LO) frequency provided by LO 25. For example, in some embodiments, mixer 30 translates the RF signal frequencies to baseband frequencies. As another example, in some embodiments, mixer 30 translates the RF signal frequencies to an intermediate frequency (IF).

Mixer 30 provides the translated output signal as a set of two signals, an in-phase (I) signal, and a quadrature (Q) signal. The I and Q signals are analog time-domain signals. Analog to digital converter (ADC) 35 converts the I and Q signals to digital I and Q signals. In exemplary embodiments, ADC 35 may use a variety of signal conversion techniques. For example, in some embodiments, ADC 35 may use delta-sigma (or sometimes called sigma-delta) analog to digital conversion.

ADC 35 provides the digital I and Q signals to signal processing circuitry 40. Generally speaking, signal processing circuitry 40 performs processing on the digital I and Q signals, for example, digital signal processing (DSP). In exemplary embodiments, signal processing circuitry 40 includes DSA 48. DSA 48, described below in detail, detects arrival of a signal communicated via an RF link, i.e., via RF signals received by antenna 15.

Signal processing circuitry 40 provides information, such as the demodulated data, to data processing circuitry 55 via link 50. Data processing circuitry 55 may perform a variety of functions (e.g., logic, arithmetic, etc.). For example, data processing circuitry 55 may use the demodulated data in a program, routine, or algorithm (whether in software, firmware, hardware, or a combination) to perform desired control or data processing tasks.

In some embodiments, data processing circuitry 55 may perform control of other circuitry, sub-system, or systems (not shown). In some embodiments, data processing circuitry 55 may provide the data (after processing, as desired, for example, filtering) to another circuit (not shown), such as a transducer, display, etc.

In exemplary embodiments, link 50 may take a variety of forms. For example, in some embodiments, link 50 may constitute a number of conductors or coupling mechanisms, such as wires, cables, printed circuit board (PCB) traces, etc. Through link 50, signal processing circuitry 40 and data processing circuitry 55 may exchange information, such as the demodulated data, control information or signals, status signals, etc., as desired.

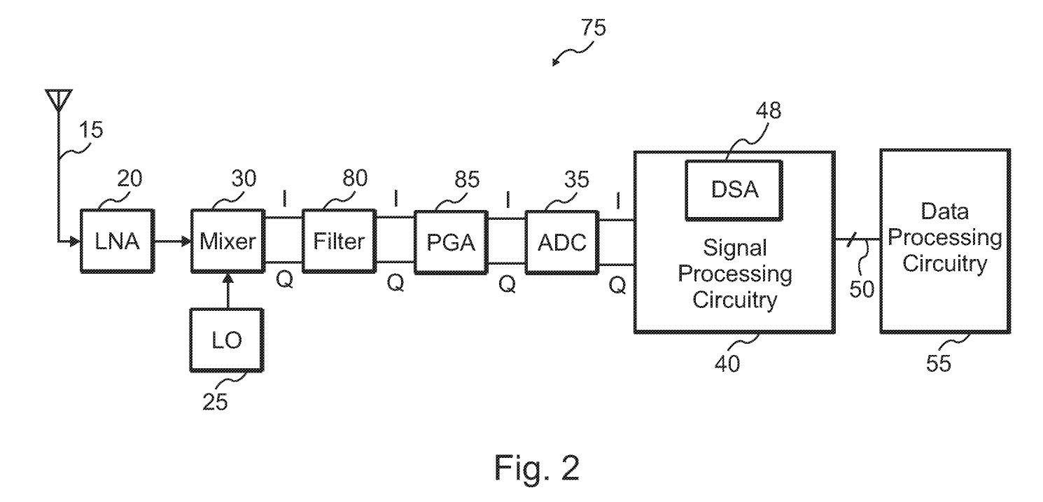

FIG. 2 depicts a circuit arrangement for a receiver 75 according to an exemplary embodiment. Receiver 75 generally has a similar architecture as receiver 10 (see FIG. 1). Thus, similar to the receiver in FIG. 1, receiver 75 in FIG. 2 includes DSA 48. Referring again to FIG. 2, receiver 75 includes a filter 80 and a programmable gain amplifier (PGA) 85. Filter 80 provides filtering of the RF or baseband signal at the output of mixer 30. PGA 85 provides programmable gain for the filtered signal at the output of filter 80.

In some embodiments, PGA 85 has a gain that is programmable for different input levels of the RF signals received by antenna 15. In some embodiments, PGA 85 has a gain that is programmable for different frequency bands of the RF signals received by antenna 15. In some embodiments, PGA 85 may include more than one stage of amplification, for example, two or more “slices” of amplifier circuitry coupled in a cascade configuration, as desired. The gain of the various stages may be programmed in a similar or independent manner, as desired.

Note that variations of receiver 75 are possible and contemplated in exemplary embodiments. For example, in some embodiments, receiver 75 may include filter 80, but not PGA 85. Conversely, as another example, in some embodiments, receiver 75 may include PGA 85, but not filter 80. Conversely, as yet another example, in some embodiments, receiver 75 may swap the order of PGA 85 and filter 80. Other possibilities exist, for example, including one or more filters between antenna 15 and LNA 20 to facilitate accommodating several RF signal bands, etc.

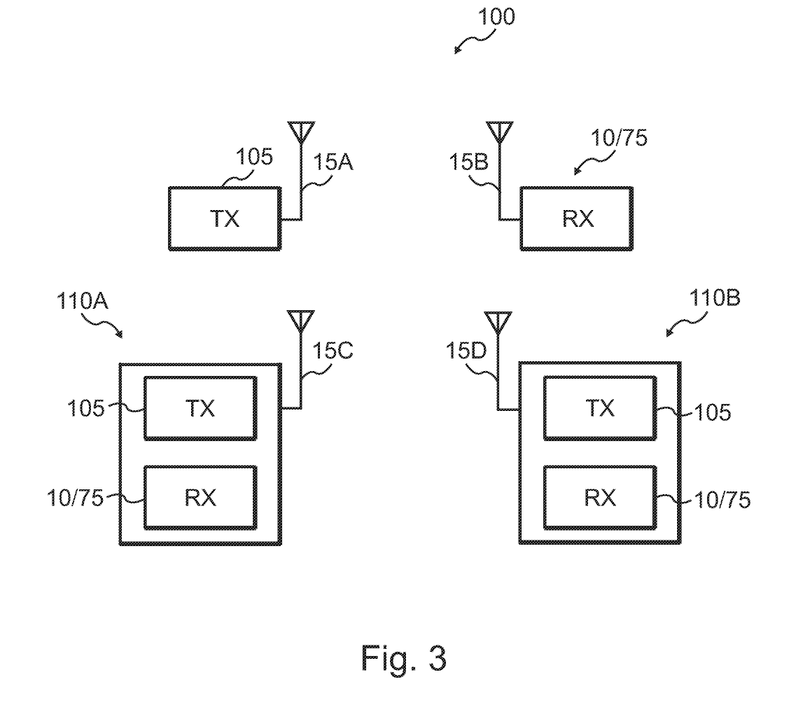

Receivers according to exemplary embodiments may be used in a variety of communication arrangements, systems, sub-systems, networks, etc., as desired. FIG. 3 shows a system 100 for radio communication according to an exemplary embodiment.

System 100 includes a transmitter 105, coupled to antenna 15A. Via antenna 15A, transmitter 105 transmits RF signals. The RF signals may be received by receiver 10, described above (alternatively, the receiver may constitute receiver 75, also described above). In addition, or alternatively, transceiver 110A and/or transceiver 110B might receive (via receiver 10 or 75) the transmitted RF signals.

In addition to receive capability, transceiver 110A and transceiver 110B can also transmit RF signals. The transmitted RF signals might be received by receiver 10 or 75, either in the stand-alone receiver, or via the receiver circuitry of the non-transmitting transceiver.

Other systems or sub-systems with varying configuration and/or capabilities are also contemplated. For example, in some exemplary embodiments, two or more transceivers (e.g., transceiver 110A and transceiver 110B) might form a network, such as an ad-hoc network. As another example, in some exemplary embodiments, transceiver 110A and transceiver 110B might form part of a network, for example, in conjunction with transmitter 105.

Referring again to FIGS. 1-2, DSA 48 operates on a signal, typically derived from baseband signal as received in receiver 75 in FIGS. 1-2 or in a receiver using another circuitry. Rather than using an architecture based on a Coordinate Rotation Digital Computer (Cordic)/differentiator architecture to detect signal arrival, DSAs (such as DSA 48 in FIGS. 1-2) according to exemplary embodiments use a frequency discriminator, as described in detail below.

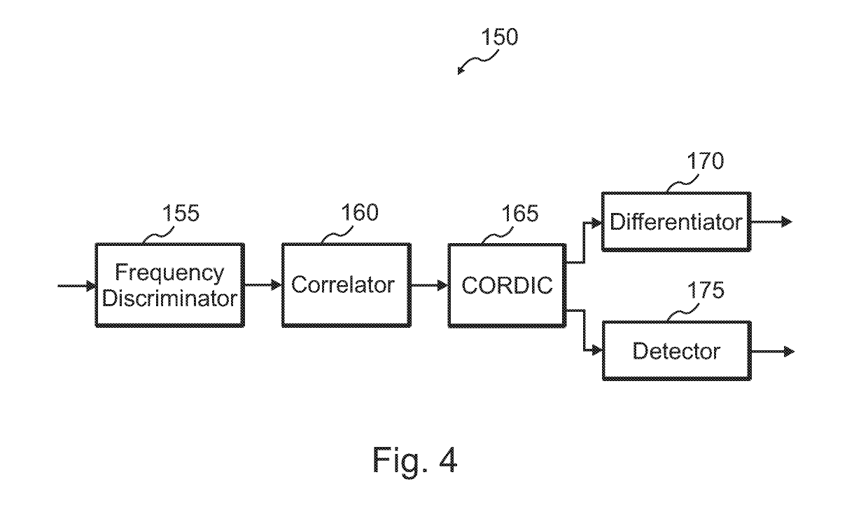

FIG. 4 depicts a circuit arrangement 150 for receive path circuitry according to an exemplary embodiment. The receive path circuitry may be included in a variety of RF receivers, such as the receivers shown in FIGS. 1-2, as desired. Referring again to FIG. 4, the receive path circuitry includes a DSA, such as DSA 48 in FIGS. 1-2. In the embodiment shown in FIG. 4, the DSA includes frequency discriminator 155, correlator 160, and Cordic (or Cordic circuit) 165.

Note that in some embodiments, other circuitry may be used instead of Cordic 165, as desired. For example, in some embodiments, an amplitude detection circuit or an amplitude detector may be used. The choice of circuitry used depends on various factors, such as design specifications, performance specifications, type/characteristics of RF signal (e.g., the modulation scheme used, noise level, signal level, etc.), channel characteristics, cost, IC or device area, available technology, such as semiconductor fabrication technology), target markets, target end-users, etc., as persons of ordinary skill in the art will understand.

The receive path circuitry in FIG. 4 further includes differentiator 170 and detector 175. Differentiator 170 and detector 175 receive the phase and magnitude outputs of Cordic 165, respectively, and process those signals as described below in detail.

Frequency discriminator 155 receives sampled time-domain signals derived from the RF signal that the receiver (including the receive path circuitry in FIG. 4) receives via a communication medium. As described below in detail, frequency discriminator 155 processes the sampled time-domain signals to generate a complex signal, which it provides to correlator 160. The complex signal includes an in-phase (I) signal and a quadrature (Q) signal. To facilitate presentation, FIG. 4 shows a single output signal of frequency discriminator 155, rather than depicting individual signals.

As described below in detail, correlator 160 processes the complex signal received from frequency discriminator and provides the resulting complex signal to Cordic 165. More specifically, correlator 160 correlates the phase of the output signal of frequency discriminator 155 with an a priori phase pattern or, put another way, functions as a phase pattern recognition circuit. Cordic 165 converts the complex signal received from correlator 160 into a phase signal and a magnitude signal. The phase signal drives an input of differentiator 170. The magnitude signal drives an input of detector 175.

Differentiator 170 and detector 175 are used, respectively, for frequency offset estimation and signal detection. More specifically, differentiator 170 receives the phase output provided by Cordic 165, and differentiates the phase to provide a frequency offset estimation. The frequency offset estimation is used by other circuitry (not shown) to make reference frequency corrections in the RF receiver or estimate the frequency offset for automatic frequency control (AFC), as persons of ordinary skill in the art will understand.

By adding Cordic 165 and differentiator 170, the DSA hardware can be reused to estimate the frequency offset to support AFC. To support this functionality, the I and Q inputs of Cordic 165 are coupled to receive output signal of correlator 160, as described above.

Detector 175 receives the magnitude signal provided by Cordic 165, and compares the magnitude signal to a threshold value. Detector 175 provides an output signal that indicates whether the magnitude signal from Cordic 165 exceeds the threshold value. Signal arrival is declared (or determined or detected) when the magnitude signal provided by Cordic 165 to detector 175 exceeds the threshold value. In exemplary embodiments, a controller (not shown) may provide the threshold value to detector 175.

As noted above, in exemplary embodiments Cordic 165 may be replaced by any other magnitude detector. For example, in some embodiments, Cordic 165 may be replaced by a function that operates on the quantity (I²+Q²)^{1/2} or on the quantity |I|+|Q|, where “|” represents the absolute value function. (Note that I and Q represent the output signals from correlator 160.)

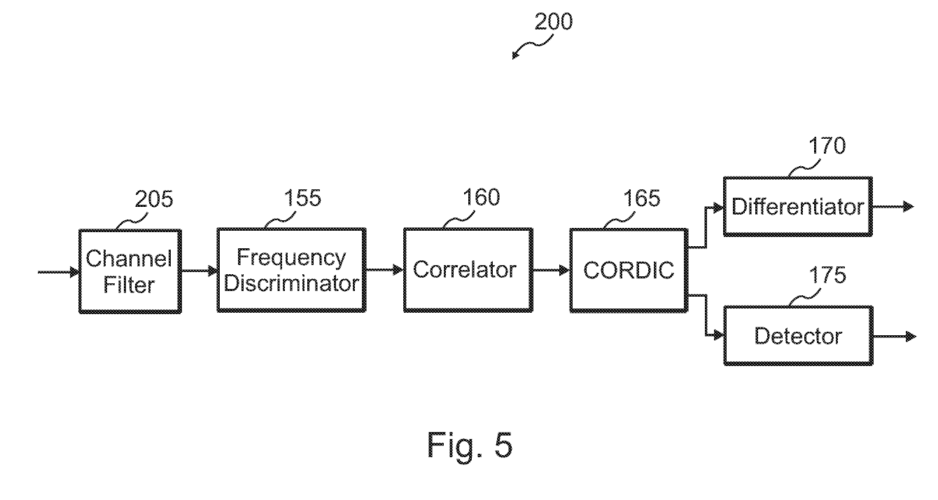

Considering again the circuit arrangement in FIG. 4, in some embodiments, a channel filter may be used in the receive path circuitry. FIG. 5 depicts a circuit arrangement 200 for receive path circuitry that includes channel filter 205. Channel filter 205 digitally filters (e.g., low-pass filtering) of its input signal, which results from the processing of a received RF signal. The digital filtering in channel filter 205 can in some situations improve the performance of the RF receiver, for example, by filtering noise, adjacent channel signals, etc., or can selectively provide a signal in a desired channel to frequency discriminator 155.

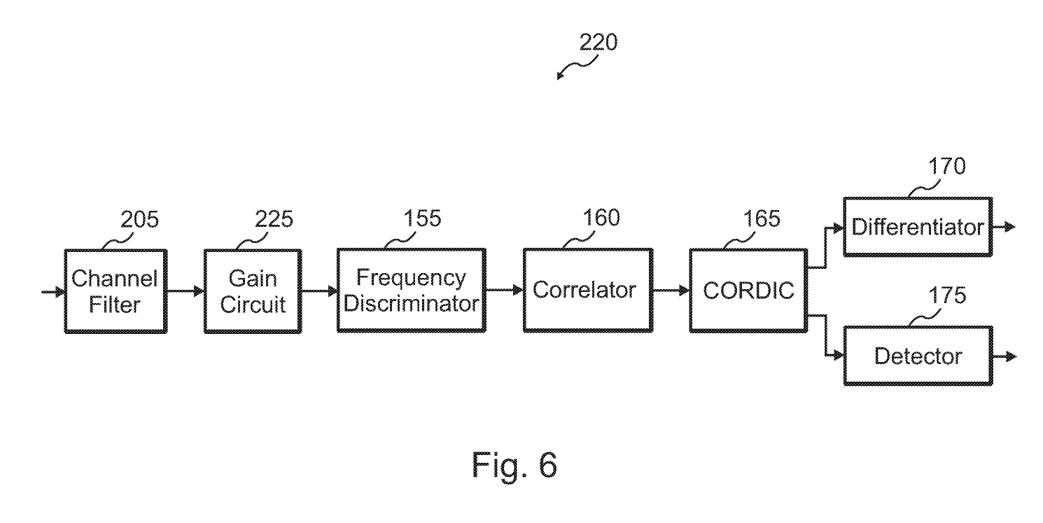

To save or reuse hardware, one or more gain control stages may be used before the DSA. As an example, FIG. 6 shows a circuit arrangement 220 that includes gain circuit 225. In the embodiment shown, channel filter 205 is used, and a gain circuit 225 is coupled between the output of channel filter 205 and frequency discriminator 155.

The output signal of frequency discriminator 155 is proportional to A², where A represents the amplitude of the input signal to frequency discriminator 155. Relatively high noise levels or automatic gain control (AGC) action might impact the magnitude of signal A. Amplitude scaling via gain circuit 225 is used so that the output signals of correlator 160 (magnitude) is independent of the input signal (A). Using the gain control stage(s), such as gain circuit 225, helps to reduce the data path length or reduce the data path length to a minimum in order to reduce the semiconductor area (e.g., in an IC used to implement the circuitry in FIG. 6) and also to reduce power consumption.

In the embodiment shown in FIG. 6, gain circuit 225 is coupled between the output of channel filter 205 and frequency discriminator 155. Gain control stage(s), however, may be used or placed in other locations in the receive path circuitry in other embodiments, as desired.

As an alternative or in addition to using gain circuit 225, in some embodiments, the threshold value used by detector 175 may be scaled. As another alternative or in addition to using gain circuit 225, in some embodiments, the input signals of FIR filters 260I-260Q may be scaled, which results in hardware reduction or savings in FIR filters 260I-260Q.

In exemplary embodiments, gain circuit 225 may be implemented by selecting a number of bits, for example 8 bits, at its input. For example, if the input is 16 bits long, say, b₁₅ to b₀, and the first four most significant bits (b₁₅ to b₁₂) are not carrying any signal information then b₁₁ to b₄ may be presented at the output of gain circuit 225. In such a scenario, the smallest gain step is 2× (gain of two). To have finer granularity or higher definition in the signal arrival detection, in some embodiments the gain control can be complemented by adjusting the threshold level in the detector 175, as desired.

The gain of the gain control stage(s) can be controlled based on a variety of criteria or signals or figures of merit, as persons of ordinary skill in the art will understand. For example, in some embodiments, receive signal strength indication (RSSI) or a signal from one or more blocks in the DSA may be used to control the gain of the gain control stage(s). Furthermore, in some embodiments, techniques may be used to reduce gain chattering in the gain control stage(s). For example, in some embodiments, stabilization techniques such as hysteresis or a fast attack/slow decay loop.

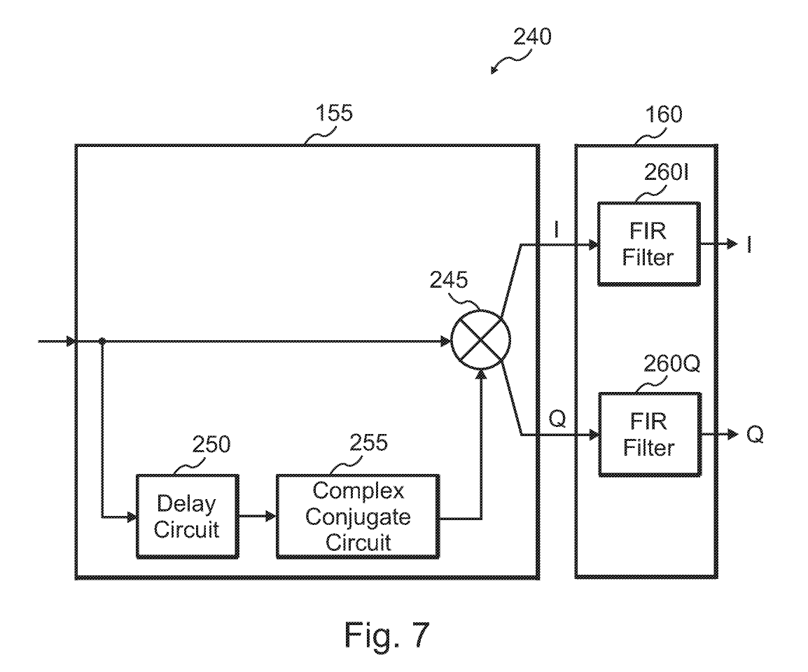

FIG. 7 depicts a circuit arrangement 240 that includes frequency discriminator 155 and correlator 160 used in a DSA according to an exemplary embodiment. The input signal of frequency discriminator 155, a sampled time-domain signal, is provided to both delay circuit 250 and to multiplier 245. Delay circuit 250 delays the input signal by a desired amount of delay, to generate a delayed signal. The delay in some embodiments is one clock cycle (of the clock signal clocking frequency discriminator 155 and other circuitry in the DSA), although in other embodiments different amounts or cycles of delay may be used, as desired.

In exemplary embodiments, delay circuit 250 may use a sample rate such that the modulation used to modulate the RF signal causes a phase change of

$$+ \frac{π}{2} or - \frac{π}{2}$$

radians (plus or minus 90 degrees) per sample period. As persons of ordinary skill in the art will understand, however, other sample rates may be used, as desired. The choice of sample rates depend on factors such as design specifications, performance specifications, type of RF signal (e.g., the modulation scheme used), cost, IC or device area, available technology, such as semiconductor fabrication technology), target markets, target end-users, etc., as persons of ordinary skill in the art will understand.

Regardless of the implementation details, the delayed signal at the output of delay circuit 250 is provided to complex conjugate circuit 255. Complex conjugate 255 generates the complex conjugate of its input signal, and provides the result to multiplier 245. For example, suppose that the delayed signal is represented by x+jy, where x and y represent, respectively, the real and imaginary parts of the signal, and j represents \sqrt{−1}. In that situation, the output of complex conjugate circuit would be the complex conjugate of x+jy, or x−jy.

Multiplier 245 multiplies the input signal of frequency discriminator 155 and the output signal of complex conjugate signal to generate a complex output signal, denoted by a signal labeled “I” and a signal labeled “Q.” The complex output signal of multiplier, i.e., the output signal of frequency discriminator 155, drive the inputs of correlator 160.

Correlator 160 includes a pair of finite impulse response (FIR) filters. More specifically, FIR filter 260I is coupled to receive the “I” signal from frequency discriminator 155. Conversely, FIR filter 260Q is coupled to receive the “Q” signal from frequency discriminator 155. FIR filter 260I filters its input signal using a desired transfer function. Similarly, FIR filter 260Q filters its input signal using a desired transfer function. FIR filters 260I and 260Q provide a complex signal, including an “I” signal and a “Q” signal, as the output signal of correlator 260. In exemplary embodiments, FIR filters 260I and 260Q constitute complex filters.

The output signals of the various blocks or circuits in FIG. 7 may be expressed as follows. Assume that U, V, W, and S denote the input signal of frequency discriminator 155, the output signal of delay circuit 250, the output signal of complex conjugate circuit 255, and the output signal of multiplier 245. Signals U, V, W, and S may be expressed, respectively, as:

$$U = A {e}^{j θ} , where θ represents the initial phase value , V = A {e}^{j θ \pm \frac{π}{2}} ( \pm \frac{π}{2} modulation relative to signal U ) , \\ W = A {e}^{- j θ \pm \frac{π}{2}} , and$$

$$S = U \cdot W = {A}^{2} {e}^{j ( θ - θ \pm \frac{π}{2} )} = {A}^{2} {e}^{j ( \pm \frac{π}{2} )} = {A}^{2} [ cos ( \pm \frac{π}{2} ) + j sin ( \pm \frac{π}{2} ) ] = \pm {A}^{2} ,$$

where A represents the amplitude or magnitude of the input signal of frequency discriminator 155, and θ represents the initial phase value of the input signal of frequency discriminator 155.

In the presence of a frequency offset, the signals U, V, W, and S may be expressed, respectively, as:

$$U = A {e}^{j θ} , \\ V = A {e}^{j θ \pm \frac{π}{2} \pm δ} , \\ W = A {e}^{- j θ \pm \frac{π}{2} \pm δ} , and$$

$$S = U \cdot W = {A}^{2} [ cos ( \pm \frac{π}{2} \pm δ ) + j sin ( \pm \frac{π}{2} \pm δ ) ] ,$$

where ±δ represents the phase change per symbol, and corresponds to the frequency offset. As noted above, following complex multiplication in multiplier 245, the cosine and sine term, carrying the phase change ±δ, provided by correlator 160 is used to address the frequency offset.

In exemplary embodiments, oversampling is used in the DSA, depending on factors such as the type of signal (e.g., the type of modulation) received. For example, in the case of BLE long range (BLE-LR) RF signals, Manchester coding is used that codes “1” into “1 1 0 0,” four chips at a one megachip per second rate, where a chip represents

$$\frac{π}{2}$$

phase change. In this case, one sample per chip suffices, as at least every other sample causes

$$\pm \frac{π}{2}$$

phase change. In the case of offset quadrature phase shift keying (O-QPSK) modulation per IEEE 802.15.4 specifications,

$$\pm \frac{π}{2}$$

phase shift occurs per chip. When the oversampling rate is one, a probability exists that samples are taken at zero crossings of the phase signal. As a result, oversampling is used (i.e., more than one sample per chip is taken (for example, in the case of O-QPSK per IEEE 802.15.4 specifications, when an oversampling rate of 2 is used, i.e. the sample rate is twice the chip rate, then at least every other sample causes

$$\pm \frac{π}{2}$$

phase change).

In exemplary embodiments, a search pattern may be programmed into FIR filters 260I-260Q. In other words, filter coefficients may be programmed into or used in FIR filters 260I-260Q that correspond to the desired search pattern or, put another way, the filter coefficients are derived from the expected modulation pattern. For example, if a SYNCH word address is known, the address may be programmed into FIR filters 260I-260Q.

In this manner, FIR filters 260I-260Q operate as a correlator. More specifically, correlator 160 correlates the phase of the output signal of frequency discriminator 155 with an a priori phase pattern (e.g., a pattern that is programmed into the filter coefficients) or, put another way, functions as a phase pattern recognition or search circuit. If a matching pattern is found during the search, the magnitude of the complex vector at the output of FIR filters 260I-260Q and, hence, the magnitude output of Cordic 165 would exhibit an increase or spike, which would then cause detector 175 to detect signal arrival.

In exemplary embodiments, a variety of search patterns may be programmed into FIR filters 260I-260Q. For example, in some embodiments a search pattern may be programmed or used that searches for the preamble or part of the preamble. As another example, in some embodiments a search pattern may be programmed or used that searches for the SYNCH word or part of the SYNCH word. As another example, in some embodiments a search pattern may be programmed or used that searches for part of the preamble and part of the SYNCH word.

In exemplary embodiments, the programming of FIR filters 260I-260Q with the desired filter coefficients may be performed in a variety of ways, as desired. As an example, in some embodiments, a controller (not shown) may be used to program the filter coefficients in FIR filters 260I-260Q.

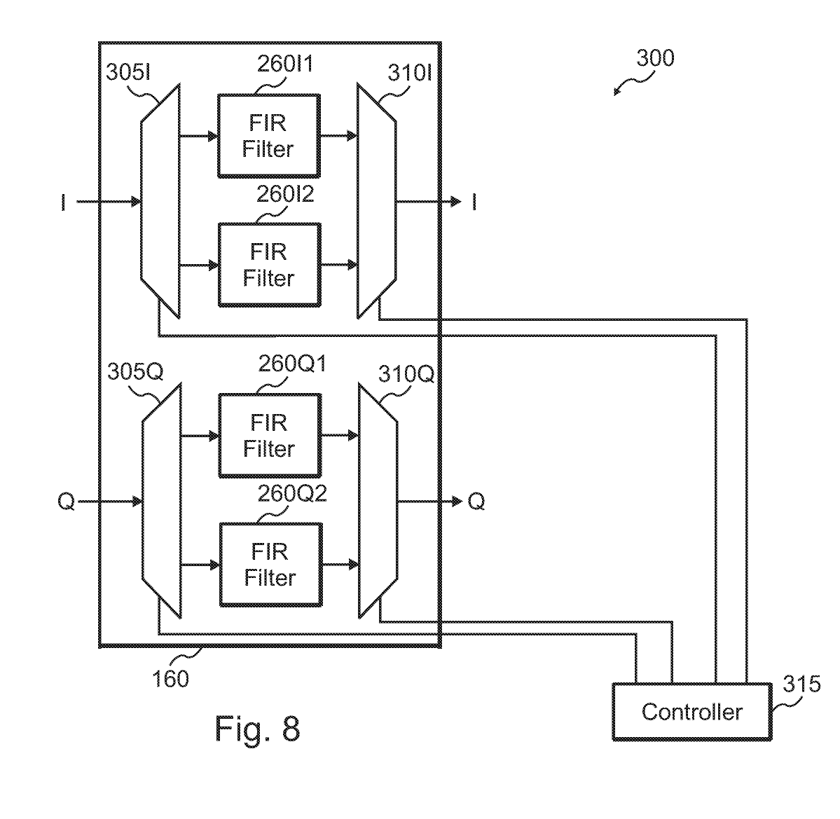

In some embodiments, correlator 160 (see FIGS. 4-7) is implemented using multiplexers (MUXs), demultiplexers (DeMUXs), and complex FIR filters. FIG. 8 shows a circuit arrangement 300 that includes this configuration. More specifically, circuit arrangement includes DeMUXs 305I-305Q, MUXs 310I-310Q, and four FIR filters 260I1-260I2 and 260Q1-260Q2.

In addition, circuit arrangement 300 includes controller 315. In exemplary embodiments, controller 315 may be implemented as a finite-state machine (FSM), as desired. Other implementations of controller 315 are also contemplated and possible. Examples include general logic circuitry, processors, custom logic, etc. The choice of circuitry for a given implementation depends on a variety of factors, as persons of ordinary skill in the art will understand. Such factors include design specifications, performance specifications, cost, IC or device area, available technology, such as semiconductor fabrication technology, target markets, target end-users, etc.

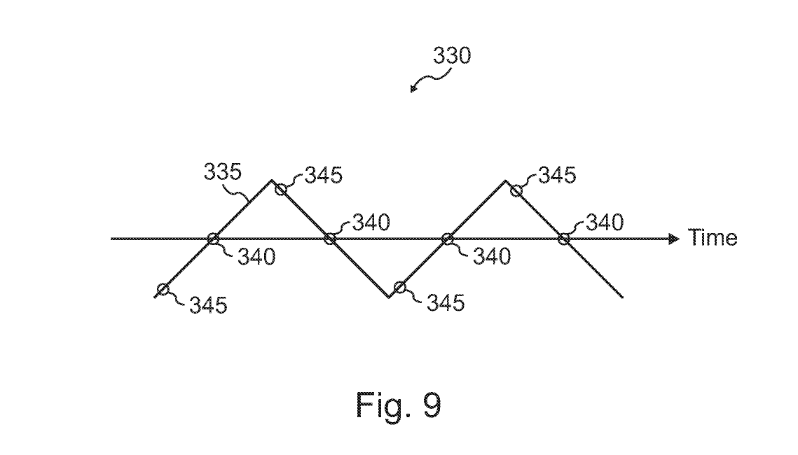

The output signal of frequency discriminator 155 (not shown) drives the inputs of correlator 160. More specifically, the in-phase (I) signal from frequency discriminator 155 drives DeMUX 305I, whereas the quadrature (Q) signal from frequency discriminator 155 drives DeMUX 305Q. Under the control of controller 315, DeMUX 305I provides the in-phase signal to either FIR filter 260I1 or FIR filter 260I2, depending on the phase value. Similarly, under the control of controller 315, DeMUX 305Q provides the quadrature signal to either FIR filter 260Q1 or FIR filter 260Q2, depending on the phase values (as described below in detail in connection with FIG. 9).

Thus, with one set of phase values, FIR filter 260I1 and FIR filter 260Q1 process the in-phase and quadrature signals from frequency discriminator 155. With the other set of phase values, FIR filter 260I2 and FIR filter 260Q2 process the in-phase and quadrature signals from frequency discriminator 155.

Under the control of controller 315, and depending on the set of phase values, MUX 310I provides either the output signal of FIR filter 260I1 or the output signal of FIR filter 260I2 as the in-phase output signal of correlator 160, which drives the in-phase input of Cordic 165. Similarly, under the control of controller 315, and depending on the set of phase values, MUX 310Q provides either the output signal of FIR filter 260Q1 or the output signal of FIR filter 260Q2 as the quadrature output signal of correlator 160, which drives the quadrature input of Cordic 165.

Phase values of the input signal of frequency discriminator 155 (not shown in FIG. 8) determine which of the FIR filters processes the signals provided to correlator 160. Consider, as an example, oversampling on an O-QPSK or MSK signal, for instance, where the oversampling rate is two, corresponding to two sets of phase values. In such situations, the two sets of FIR filters are used such that one set of FIR filters in FIG. 8 processes input signals corresponding to one of the two sets of phase values, and that the other set of FIR filters processes input signal that corresponding to the other set of phase values. Stated another way, one set of FIR filters processes odd phases or phase values, whereas the other set of FIR filters processes even phases or phase values.

FIG. 9 illustrates two sets of phase values in an exemplary embodiment. More specifically, plot 330 depicts phase waveform 335 of the input signal of frequency discriminator 155. One set of phase values is labeled as 340, and a second set of phase values is labeled as 345. As discussed above in connection with FIG. 8, with one set of phase values, say, set 340, the output signal of frequency discriminator 155 is processed by FIR filters 260I1 and 260Q1, whereas with the other set of phase values, set 345, the output signal of frequency discriminator 155 is processed by FIR filters 260Q1 and 260Q2.

As described above, the filter coefficients of FIR filters 260I1-260I2 and 260Q1-260Q2 are programmed that correspond to the desired search pattern. In the exemplary embodiment shown in FIG. 8, controller 315 programs the filter coefficients. In exemplary embodiments, the number of taps in each of FIR filters 260I1-260I2 and 260Q1-260Q2 corresponds to the number of bits in the desired search window.

As also noted above, detector 175 (not shown in FIG. 8) is used to detect signal arrival. In some embodiments, to provide timing detection, if the output of Cordic 165 provided to detector 175 exceeds the threshold value, an examination of phase values may continue for an amount of time (e.g., one symbol period) to search for the phase value that corresponds to maximum amplitude at the output of Cordic 165. The phase value that corresponds to the maximum magnitude can be used to derive an estimate of the frequency offset. For example, in exemplary embodiments, the output of differentiator 170 in FIGS. 4, 5, and 6 can be used to derive an estimate of the frequency offset.

Furthermore, in some embodiments the frequency offset is sampled when the magnitude at the output of Cordic 165 driving detector 175 exceeds the threshold value. Then several frequency offsets are stored in subsequent samples. The frequency offsets that correlates with the maximum magnitude at the output of Cordic 165 (as detected by detector 175) is used for frequency offset estimation, for example, as part of AFC scheme.

Depending on the specifics of given implementations, some measures may be taken to reduce hardware amount and complexity, which typically reduces the overall RF receiver power consumption. For example, at relatively high (higher than two) oversampling rates, some phase values may be skipped. For instance, with an oversampling rate of four, the second and fourth phase values may be excluded, or partly excluded, from the processing, i.e., they are not, or partly, included or processed in frequency discriminator 155 and correlator 160.

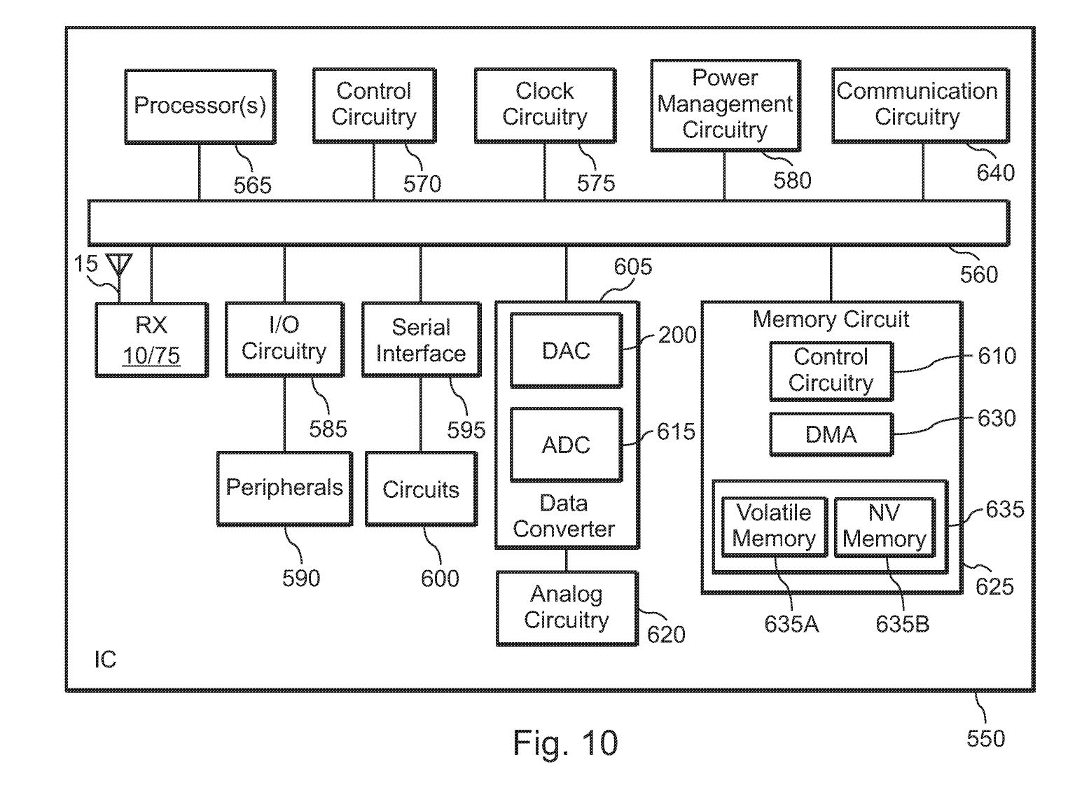

Receivers according to exemplary embodiments may be combined with other circuitry, for example, by integrating the receiver and signal processing, logic, or computing circuitry within an IC. FIG. 10 illustrates an IC 550, for example, a microcontroller unit (MCU), that combines a receiver with other circuit blocks according to an exemplary embodiment. IC 550 includes a number of blocks (e.g., processor(s) 565, data converter 605, I/O circuitry 585, etc.) that communicate with one another using a link 560. In exemplary embodiments, link 560 may constitute a coupling mechanism, such as a bus, a set of conductors or semiconductors for communicating information, such as data, commands, status information, and the like.

IC 550 may include link 560 coupled to one or more processors 565, clock circuitry 575, and power management circuitry 580. In some embodiments, processor(s) 565 may include circuitry or blocks for providing computing functions, such as central-processing units (CPUs), arithmetic-logic units (ALUs), and the like. In some embodiments, in addition, or as an alternative, processor(s) 565 may include one or more digital signal processors (DSPs). The DSPs may provide a variety of signal processing functions, such as arithmetic functions, filtering, delay blocks, and the like, as desired. In some embodiments, functionality of parts of receiver 10/75, such as those described above, may be implemented or realized using some of the circuitry in processor(s) 565, as desired.

Referring again to FIG. 10, clock circuitry 575 may generate one or more clock signals that facilitate or control the timing of operations of one or more blocks in IC 550. Clock circuitry 575 may also control the timing of operations that use link 560. In some embodiments, clock circuitry 575 may provide one or more clock signals via link 560 to other blocks in IC 550.

In some embodiments, power management circuitry 580 may reduce an apparatus's (e.g., IC 550) clock speed, turn off the clock, reduce power, turn off power, or any combination of the foregoing with respect to part of a circuit or all components of a circuit. Further, power management circuitry 580 may turn on a clock, increase a clock rate, turn on power, increase power, or any combination of the foregoing in response to a transition from an inactive state to an active state (such as when processor(s) 565 make a transition from a low-power or idle or sleep state to a normal operating state).

Link 560 may couple to one or more circuits 600 through serial interface 595. Through serial interface 595, one or more circuits coupled to link 560 may communicate with circuits 600. Circuits 600 may communicate using one or more serial protocols, e.g., SMBUS, I²C, SPI, and the like, as person of ordinary skill in the art will understand.

Link 560 may couple to one or more peripherals 590 through I/O circuitry 585. Through I/O circuitry 585, one or more peripherals 590 may couple to link 560 and may therefore communicate with other blocks coupled to link 560, e.g., processor(s) 365, memory circuit 625, etc.

In exemplary embodiments, peripherals 590 may include a variety of circuitry, blocks, and the like. Examples include I/O devices (keypads, keyboards, speakers, display devices, storage devices, timers, etc.). Note that in some embodiments, some peripherals 590 may be external to IC 550. Examples include keypads, speakers, and the like. In some embodiments, with respect to some peripherals, I/O circuitry 585 may be bypassed. In such embodiments, some peripherals 590 may couple to and communicate with link 560 without using I/O circuitry 585. Note that in some embodiments, such peripherals may be external to IC 550, as described above.

Link 560 may couple to analog circuitry 620 via data converter 605. Data converter 405 may include one or more ADCs 615 and/or one or more DACs 200. The ADC(s) 615 receive analog signal(s) from analog circuitry 620, and convert the analog signal(s) to a digital format, which they communicate to one or more blocks coupled to link 560. Conversely, DAC(s) 200 receive one or more digital signals from one or more blocks coupled to link 560, and convert the digital signal(s) to an analog format. The analog signal(s) may be provided to circuitry within (e.g., analog circuitry 620) or circuitry external to IC 550, as desired. Analog circuitry 620 may include a wide variety of circuitry that provides and/or receives analog signals. Examples include sensors, transducers, and the like, as person of ordinary skill in the art will understand. In some embodiments, analog circuitry 620 may communicate with circuitry external to IC 550 to form more complex systems, sub-systems, control blocks, and information processing blocks, as desired.

Control circuitry 570 couples to link 560. Thus, control circuitry 570 may communicate with and/or control the operation of various blocks coupled to link 560. In addition or as an alternative, control circuitry 570 may facilitate communication or cooperation between various blocks coupled to link 560. In some embodiments, the functionality or circuitry of control circuits in receiver 10/75 (e.g., controller 170 or 250 described above) may be combined with or included with the functionality or circuitry of control circuitry 570, as desired.

Referring again to FIG. 10, in some embodiments, control circuitry 570 may initiate or respond to a reset operation. The reset operation may cause a reset of one or more blocks coupled to link 560, of IC 550, etc., as person of ordinary skill in the art will understand. For example, control circuitry 570 may cause receiver 10/75 to reset to an initial state. In exemplary embodiments, control circuitry 570 may include a variety of types and blocks of circuitry. In some embodiments, control circuitry 570 may include logic circuitry, FSMs, or other circuitry to perform a variety of operations, such as the operations described above.

Communication circuitry 640 couples to link 560 and also to circuitry or blocks (not shown) external to IC 550. Through communication circuitry 640, various blocks coupled to link 560 (or IC 550, generally) can communicate with the external circuitry or blocks (not shown) via one or more communication protocols. Examples include universal serial bus (USB), Ethernet, and the like. In exemplary embodiments, other communication protocols may be used, depending on factors such as specifications for a given application, as person of ordinary skill in the art will understand.

As noted, memory circuit 625 couples to link 560. Consequently, memory circuit 625 may communicate with one or more blocks coupled to link 560, such as processor(s) 365, control circuitry 570, I/O circuitry 585, etc. In the embodiment shown, memory circuit 625 includes control circuitry 610, memory array 635, and direct memory access (DMA) 630. Control circuitry 610 controls or supervises various operations of memory circuit 625. For example, control circuitry 610 may provide a mechanism to perform memory read or write operations via link 360. In exemplary embodiments, control circuitry 610 may support various protocols, such as double data rate (DDR), DDR2, DDR3, and the like, as desired. In some embodiments, the memory read and/or write operations involve the use of one or more blocks in IC 550, such as processor(s) 565. DMA 630 allows increased performance of memory operations in some situations. More specifically, DMA 630 provides a mechanism for performing memory read and write operations directly between the source or destination of the data and memory circuit 625, rather than through blocks such as processor(s) 565.

Memory array 635 may include a variety of memory circuits or blocks. In the embodiment shown, memory array 635 includes volatile memory 635A and non-volatile (NV) memory 635B. In some embodiments, memory array 635 may include volatile memory 635A. In some embodiments, memory array 635 may include NV memory 635B. NV memory 635B may be used for storing information related to performance or configuration of one or more blocks in IC 550. For example, NV memory 635B may store configuration information related to various operations of receiver 10/75 and/or to initial or ongoing configuration or control of receiver 10/75, as desired.

As described above in detail, receiver 10/75 receives RF signals via antenna 15, and processes those signals. The resulting data signals are provided to one or more blocks of circuitry in IC 550 via link 560. Furthermore, various blocks of circuitry in IC 550 may be used to process the received data and to generate additional data or signals, which may be used to control other circuitry, etc. In some embodiments, a transmitter (not shown) may be included in IC 550. In such configurations, the transmitter may transmit information generated or processed in IC 550, such as information derived from, based on, or related to data received by receiver 10/75. Thus, sophisticated control and communication subsystems, blocks, circuits, or systems for processing information and/or control may be implemented.

Various circuits and blocks described above and used in exemplary embodiments may be implemented in a variety of ways and using a variety of circuit elements or blocks. For example, frequency discriminator 155, correlator 160, Cordic 165, differentiator 170, detector 175, channel filter 205, gain circuit 225, delay circuit 250, complex conjugate circuit 255, multiplier 245, FIR filter 260I, FIR filter 260Q, FIR filter 260I1, FIR filter 260I2, FIR filter 260Q1, FIR filter 260Q2, DeMUX 305I-Q, MUX 310I-Q, and controller 315 may generally be implemented using digital circuitry. The digital circuitry may include circuit elements or blocks such as gates, digital multiplexers (MUXs), latches, flip-flops, registers, finite state machines (FSMs), processors, programmable logic (e.g., field programmable gate arrays (FPGAs) or other types of programmable logic), arithmetic-logic units (ALUs), standard cells, custom cells, etc., as desired, and as persons of ordinary skill in the art will understand. In addition, analog circuitry or mixed-signal circuitry or both may be included, for instance, power converters, discrete devices (transistors, capacitors, resistors, inductors, diodes, etc.), and the like, as desired. The analog circuitry may include bias circuits, decoupling circuits, coupling circuits, supply circuits, current mirrors, current and/or voltage sources, filters, amplifiers, converters, signal processing circuits (e.g., multipliers), detectors, transducers, discrete components (transistors, diodes, resistors, capacitors, inductors), analog MUXs and the like, as desired, and as persons of ordinary skill in the art will understand. The mixed-signal circuitry may include analog to digital converters (ADCs), digital to analog converters (DACs), etc.) in addition to analog circuitry and digital circuitry, as described above, and as persons of ordinary skill in the art will understand. The choice of circuitry for a given implementation depends on a variety of factors, as persons of ordinary skill in the art will understand. Such factors include design specifications, performance specifications, cost, IC or device area, available technology, such as semiconductor fabrication technology), target markets, target end-users, etc.

Referring to the figures, persons of ordinary skill in the art will note that the various blocks shown might depict mainly the conceptual functions and signal flow. The actual circuit implementation might or might not contain separately identifiable hardware for the various functional blocks and might or might not use the particular circuitry shown. For example, one may combine the functionality of various blocks into one circuit block, as desired. Furthermore, one may realize the functionality of a single block in several circuit blocks, as desired. The choice of circuit implementation depends on various factors, such as particular design and performance specifications for a given implementation. Other modifications and alternative embodiments in addition to the embodiments in the disclosure will be apparent to persons of ordinary skill in the art. Accordingly, the disclosure teaches those skilled in the art the manner of carrying out the disclosed concepts according to exemplary embodiments, and is to be construed as illustrative only. Where applicable, the figures might or might not be drawn to scale, as persons of ordinary skill in the art will understand.

The particular forms and embodiments shown and described constitute merely exemplary embodiments. Persons skilled in the art may make various changes in the shape, size and arrangement of parts without departing from the scope of the disclosure. For example, persons skilled in the art may substitute equivalent elements for the elements illustrated and described. Moreover, persons skilled in the art may use certain features of the disclosed concepts independently of the use of other features, without departing from the scope of the disclosure.

1. An apparatus comprising:
a radio frequency (RF) receiver comprising:
a digital signal arrival (DSA) detector to detect arrival of a transmitted signal, the DSA detector comprising:
a frequency discriminator to receive a signal derived from a received RF signal to generate a first complex signal;
a correlator coupled to receive and process the first complex signal and to generate a second complex signal; and
a Coordinate Rotation Digital Computer (Cordic) circuit to receive and process the second complex signal to generate a phase signal and a magnitude signal.

2. The apparatus according to claim 1, wherein the frequency discriminator comprises:
a delay circuit to delay the signal derived from the received RF signal to generate a delayed signal;
a complex conjugate circuit to generate a complex conjugate of the delayed signal; and
a multiplier to multiply the signal derived from the received RF signal with the complex conjugate of the delayed signal to generate the first complex signal.

3. The apparatus according to claim 1, further comprising a differentiator to differentiate the phase signal.

4. The apparatus according to claim 1, further comprising a detector to compare the magnitude signal with a threshold to determine signal arrival.

5. The apparatus according to claim 1, wherein the correlator comprises a plurality of finite impulse response (FIR) filters.

6. The apparatus according to claim 5, wherein coefficients of the plurality of FIR filters correspond to a desired search pattern.

7. The apparatus according to claim 6, wherein the coefficients of the plurality of FIR filters are derived from an expected modulation pattern.

8. The apparatus according to claim 5, wherein subsets of the plurality of FIR filters process the first complex signal depending on phase values of the signal derived from the received RF signal.

9. The apparatus according to claim 5, further comprising a controller to provide filter coefficients to the plurality of FIR filters.

10. The apparatus according to claim 5, wherein the plurality of FIR filters comprise complex FIR filters.

11. An integrated circuit (IC), comprising:
a radio frequency (RF) receiver, comprising:
a digital signal arrival (DSA) detector to detect arrival of a transmitted signal, the DSA detector comprising:
a frequency discriminator to process a signal derived from a received RF signal to generate a first complex signal;
a correlator, comprising a plurality of finite impulse response (FIR) filters, coupled to receive and process the first complex signal and to correlate a phase of the first complex signal with a phase pattern to generate a second complex signal; and
a Coordinate Rotation Digital Computer (Cordic) circuit to receive and process the second complex signal to generate a phase signal and a magnitude signal.

12. The apparatus according to claim 11, wherein the plurality of FIR filters comprise complex filters.

13. The apparatus according to claim 11 wherein, depending on phase values of the first complex signal, first and second subsets of the plurality of FIR filters process the first complex signal.

14. The apparatus according to claim 11, wherein the phase signal and the magnitude signal are used, respectively, to generate a frequency offset signal, and to generate a signal arrival indication depending on whether the magnitude signal exceeds a threshold value.

15. A method of receiving radio frequency (RF) signals, the method comprising:
using a digital signal arrival (DSA) detector to detect arrival of a transmitted signal by:
processing a signal derived from an RF signal in a frequency discriminator to generate a first complex signal;
filtering the first complex signal in a correlator to generate a second complex signal; and
generating a phase signal and a magnitude signal by processing the second complex signal in a Coordinate Rotation Digital Computer (Cordic).

16. The method according to claim 15, wherein processing the signal derived from the RF signal in the frequency discriminator comprises:
delaying the signal derived from the RF signal to generate a delayed signal;
generating a complex conjugate of the delayed signal; and
multiplying the signal derived from the RF signal with the complex conjugate to generate the second first complex signal.

17. The method according to claim 15, further comprising differentiating the phase signal to determine a frequency offset.

18. The method according to claim 15, further comprising comparing the magnitude signal with a threshold to determine arrival of the RF signal.

19. The method according to claim 15, wherein filtering the first complex signal in the correlator comprises filtering the first complex signal using a plurality of complex finite impulse response (FIR) filters.

20. The method according to claim 19, wherein filtering the first complex signal using the plurality of complex FIR filters comprises using subsets of the plurality of FIR filters depending on phase values of the signal derived from the RF signal.
